(19) United States
(12) Patent Application Publication
(10) Pub. No.: US 2013/0343043 A1
(43) Pub. Date: Dec. 26, 2013

(54) Kind of LED Rechargeable Floodlight

(71) Applicant: Steven G. Brown, Sarasota, FL (US)

(72) Inventor: Xianlong Yu, Hangzhou (CN)

(21) Appl. No.: 13/857,124

(22) Filed: Apr. 4, 2013

(30) Foreign Application Priority Data
Apr. 5, 2012 (CN) 201220139511.8

(51) Int. Cl. F21L 4/08

(52) U.S. Cl. CPC F21L 4/08
USPC 362/183

(57) ABSTRACT

An led lamp shell reflecting cup led integrated lamp core fixing frame and surface of non-light tight piece said reflecting bowl installed on the led lamp in the shell said led integrated lamp wick is installed on the reflecting bowl is the surface of the non-light tight sheet is installed on the fixing frame of the fixed frame and led lamp is connected with the shell wherein: It also comprises chargeable lithium ion battery control circuit board back cover electric box and the bottom bracket the back cover electric appliance box and led lamp is connected with the shell of said chargeable lithium ion battery and control circuit board are installed in the back cover electric appliance box in the said bottom bracket is installed on the led lamp of the outer shell of the lower part of said chargeable lithium ion battery.

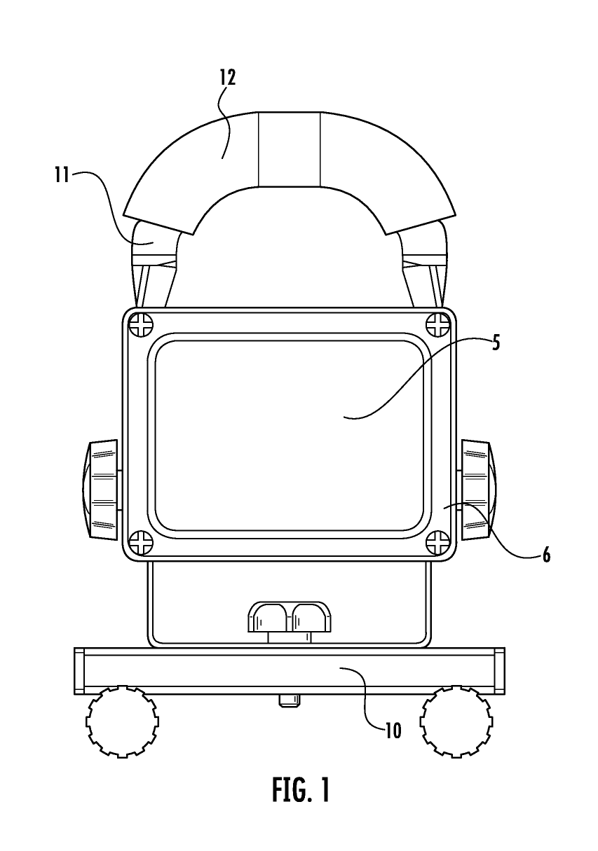

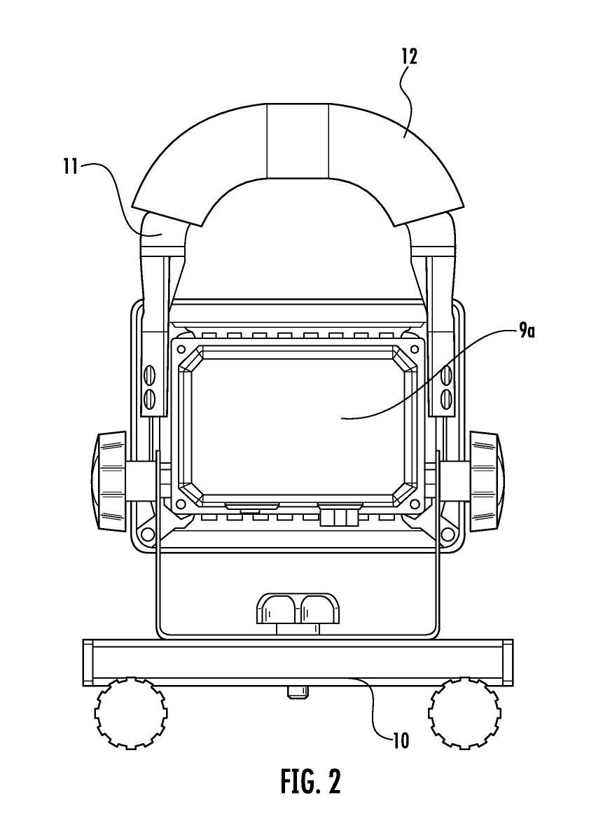

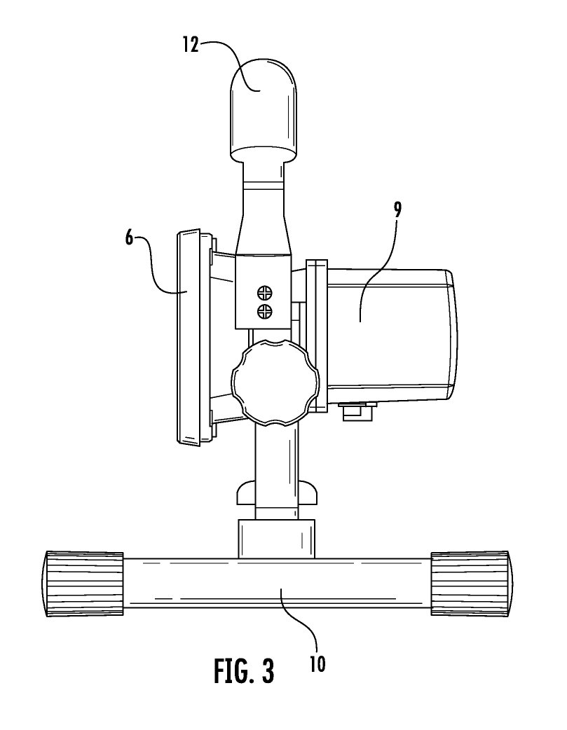

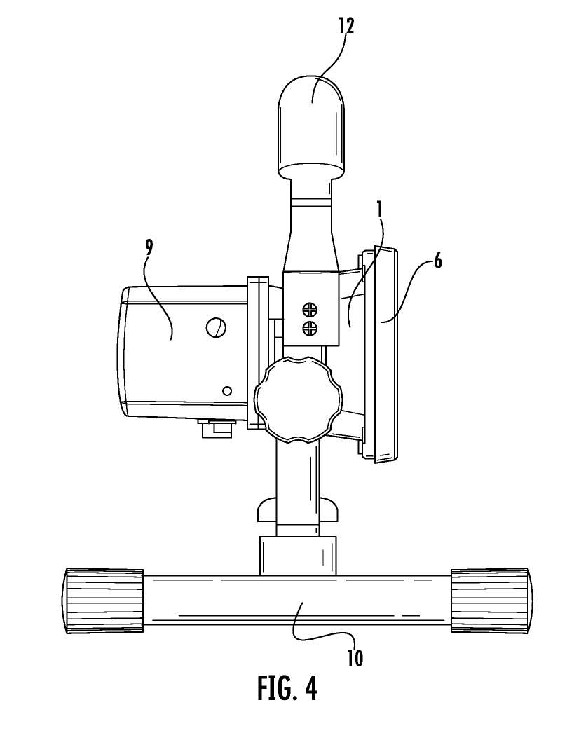

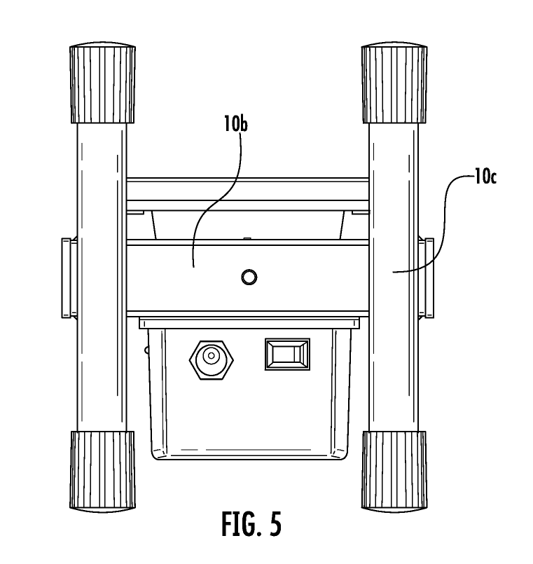

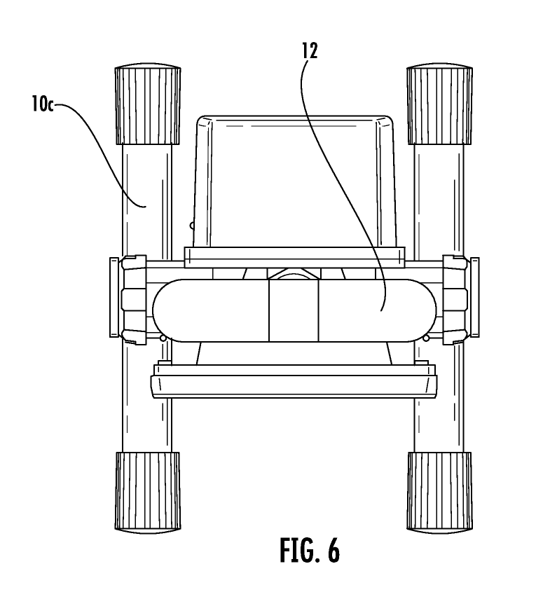

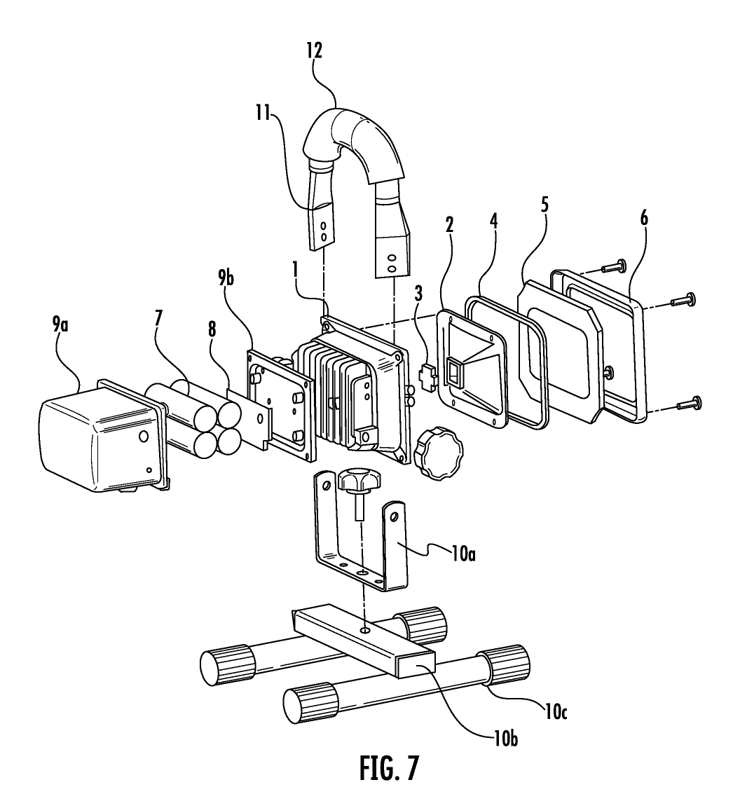

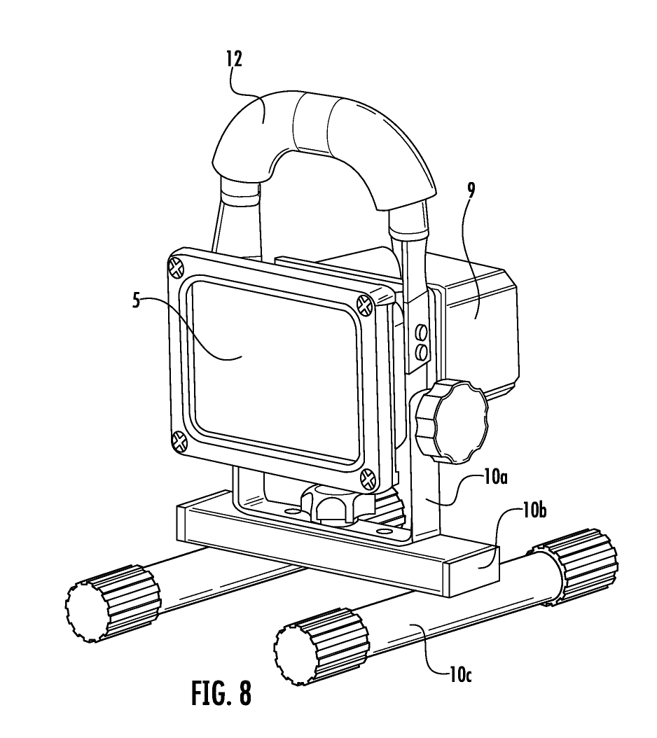

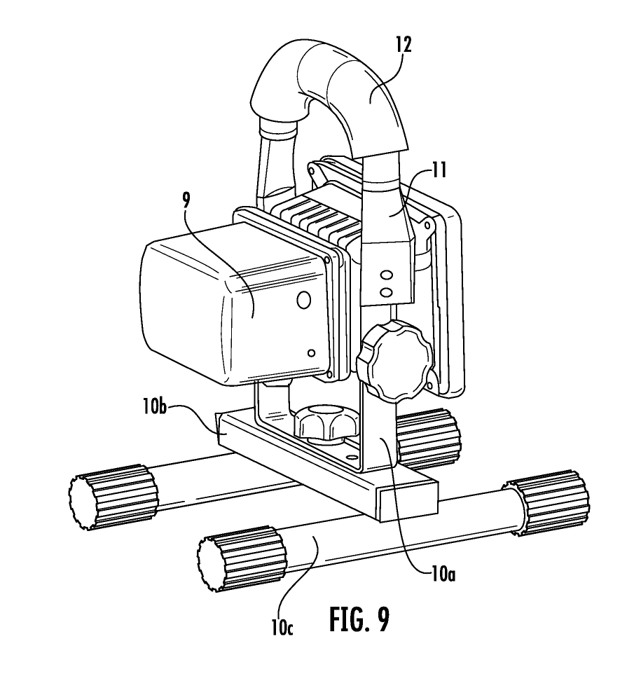

### THE TECHNICAL FIELD OF

this utility model claims a lamp especially a charging mode led flood light it is mainly suitable for automobile repair factory personal outdoor automobile maintenance overhaul camping outdoor lighting and other occasions.

### BACKGROUND TECHNOLOGY

Length 0002 a led working lamp is used for light emitting diode as light source lamp led working lamp at the same brightness of the power consumption is only has common light fitting of the ¼ of the left and right and the useful life reaches ten years carry and it is compared with traditional lamp so it is convenient to be widely used for such as on the vehicle maintenance the processing workshop of construction site and so on. And along with the normal state of vehicle and household appliance the increasingly lots of led working lamp in family the application of it is more and more. Existing similar products led floodlight with power supply line 120 v and 220 v input as the working power source when it is suitable for an electric fence is on the active site and it makes the use of the very inconvenient. Utility model claims a content

of this utility model aims at overcoming the existing technique the disadvantage that the invention claims a structure of this utility model has reasonable design simple structure it is convenient to use and carry it has high safety can be put it is convenient to use life is long it does not need to connected with the electric fence and it also can work of the charging mode led floodlight.

this utility model solves said problem the adopted technical plan is as follows: The charging mode led flood light lamp comprises led lamp shell reflecting cup led integrated lamp core fixing frame and surface of non-light tight piece said reflecting bowl installed on the led lamp in the shell said led integrated lamp wick is installed on the reflecting bowl is the surface of the non-light tight sheet is installed on the fixing frame of the fixed frame and led lamp is connected with the shell of

the structure feature is that: It also comprises chargeable lithium ion battery control circuit board back cover electric box and the bottom bracket the back cover electric appliance box and led lamp is connected with the shell of said chargeable lithium ion battery and control circuit board are installed in the back cover electric appliance box in the said bottom bracket is installed on the led lamp of the outer shell of the lower part of said chargeable lithium ion battery and led integrated lamp core are connected with control circuit board is electrically connected to the.

this utility model also comprises at least one rubber sealing ring the rubber sealing ring installed on the led lamp shell and the surface of the transparent sheet between.

this utility model also comprises a handle and handle of sponge cushion the handle and led lamp is connected with the shell of said handle is sleeved with sponge cushion is set on the handle.

this utility model said bottom bracket comprises the bracket connecting piece of the supporting bar and two of the bracket seat of said two support frame base is fixed on the bracket rod is installed on said the bracket connecting piece fixed on supporting rod the bracket connecting piece and the led lamp is connected with the shell of

this utility model also comprises ship type switch the charging socket and led bicolour indicating lamp wherein said ship type switch the charging socket and led bicolour indicating lamp are installed in the back cover electric appliance box is.

this utility model claims a chargeable lithium ion battery is 18650 type lithium ion battery and/or polymer lithium ion battery.

this utility model claims a led lamp the outer shell is aluminum.

this utility model the surface of the non-light tight sheet is made up of glass.

this utility model compared with existing technology has the following advantages and effects: The chargeable lithium ion battery and control circuit board are installed in the back cover electric appliance box it makes the structure is more compact the volume is small it is easy to carry the back cover electric appliance box in each part of the connection between the line is short the cost is saved. Installed at the bottom of the bracket so that the user can be more convenient to put charging mode led flood light in the outdoor the charging mode led flood light lamp put on the ground it is convenient and quick to use. Equipped with rubber sealing ring can prevent the water enters into the charging mode led floodlight the inner part of damaging the charging mode led floodlight the inner part of Set with the handle of sponge cushion is set in the handle can be convenient for the user to carry charging mode led floodlight. Charging mode led flood light energy using efficiency is high it has small volume light weight it is convenient to carry.

### SPECIFICATION ATTACHED DRAWING

image i is the utility model of the embodiment of the charging mode led floodlight of the main view structure conventional diagram.

picture 2 the utility model of the embodiment of the charging mode led floodlight rear view structure conventional diagram.

picture 3 is this utility model of the embodiment of the charging mode led floodlight of the left vision structure conventional diagram.

drawing 4 the utility model of the embodiment of the charging mode led floodlight of the right vision structure conventional diagram.

image ] [ 5 the utility model of the embodiment of the charging mode led floodlight of the upward view structure conventional diagram.

picture 6 is this utility model of the embodiment of the charging mode led flood light lamp of top view structure conventional diagram.

graph 7 the utility model of the embodiment of the charging mode led flood light lamp of explosion structure conventional diagram.

image 8 is the utility model of the embodiment of the charging mode led flood light lamp of solid structure conventional diagram.

image 9 the utility model of the embodiment of the charging mode led floodlight the other one of the visual angle of the solid structure conventional diagram.

### SPECIFIC IMPLEMENTING MANNER

a lower surface of the attached drawing through the embodiment of this utility model is further detailed explain of the following it is the embodiment of this utility model the explanation of this utility model is not limited to following embodiment.

### EMBODIMENT

picture 9 the i picture the embodiment of the charging mode led flood light lamp comprises led lamp outer shell i light reflecting bowl 2 led integrated lamp core 3 the rubber sealing ring on the surface of transparent sheet 5 fixing frame 6 chargeable lithium ion battery 7 control circuit board 8 the back cover electric appliance box the bottom bracket 9 10 11 and the handle the handle of sponge cushion 12. Led lamp outer shell i as aluminum it also can be made of plastic or other materials. Surface of non-light tight piece 5 the surface of glass or is transparent plastic material or for other materials.

light reflecting bowl 2 is fixed on the led lamp outer shell i the led integrated lamp core 3 is installed on the light reflecting bowl 2 and glisten bowl 2 is in paraboloid shape structure with centralized action of the light. Surface of the non-light tight sheet 5 is installed on the fixing frame 6 is fixed in the frame 6 through four screw is fixed on the led lamp outer shell i is fixed on the frame 6 and led lamp outer shell i form a hollow cavity of the led integrated lamp core 3 the rubber sealing ring 4 and the surface of the transparent sheet 5 is located in the hollow cavity.

front and back cover electric appliance box 9 it is composed of back cover 9a and electric appliance box board are composed of electric appliance box plates are fixed in the back cover 9a on the electric appliance box and the back cover board are 9a to form a closed space the closed space can protect installed in the inner part of each part of the safety of preventing these components by the wet air or other substance the erosion of.

chargeable lithium ion battery 7 and control circuit board 8 is set on the back cover electric appliance box 9 in the inner part of the chargeable lithium ion battery 7 and control circuit board 8 are electrically connected to control circuit board 8 the power supply control circuit board 8 and led integrated lamp core 3 is electrically connected with the control led integrated lamp core 3 the opening of the closing and adjusting luminance in operation.

9a front and back cover is installed on the ship type switch the charging socket and led bicolour indicating light ship type switch the charging socket and led bicolour indicating lamp are and control circuit board electrically connected with 8. Ship type switch for controlling switch controls the led integrated lamp core 3 the opening and closing and adjusting * of such as.

handle 11 is u-shaped structure handle 11 and led lamp outer shell i rotatably connected with handle 11 and the led lamp outer shell i to rotate on it is convenient for user using. Handle of sponge cushion 12 is sleeved on the handle 11 the handle on the spongy cushion 12 with elasticity make the user so it is more comfortable.

the bottom bracket 10 comprises the bracket is connected with the back part of the supporting bar iob and the bracket seat a bracket seat ioc the number of the two of the bracket seat ioc is cylinder shaped structure can adapt to different landform. Ioc of the bracket seat through bolt fixed on the cuboid structure of the bracket rod iob on the two ends of the bracket seat ioc are respectively installed on the bracket rod iob the two ends of the keep of the supporting bar the balance iob. The bracket connecting piece ioa is u-shaped frame connecting piece ioa the bottom of the fixed on the support rod iob on the bracket connecting piece ioa two arms of the outer shell i and led lamp is rotatably connected to.

the embodiment of the led integrated lamp wick using 3005 lamp this utility model claims a led integrated lamp core 3 can be used as the large power lamp core.

control circuit board 8 with led constant current discharging lithium ion battery constant current constant voltage charging battery with low pressure protection working temperature of the protection etc it can satisfy the dc12v 28v the input voltage of the charging.

chargeable lithium ion battery 7 18650 model uses lithium ion battery and/or polymer lithium battery. According to charging mode led floodlight the power can be used with different capacity chargeable lithium ion battery 7.

the embodiment of the charging mode led flood light it also can be provided with charging adapter cigar lighter and vehicle charging wire.

it opens a power supply led indicating lamp indication red light emitting diode floodlight light and it can provide illumination when the battery is not when the led indicator light twinkling red led flood light lamp charging mode can be put in the time more than 3 hours.

charging mode led flood light lamp can adopt several charging method charging time red and green lights flash alternately when the power is filled with green light chang-liang. Can be applied to 120 v or 230 v ac to dc/1000 or 24v500 ma ma ma ma 1500 to 2000 adapter for charging it also can be realized by automobile cigar lighter is connected with the line to the charging mode led floodlight for charging charging time is less than 6 hours.

charging mode led floodlight the whole structure is tightly matched and combined part matched with the rubber sealing ring 4 and it has waterproof function. Charging mode led flood light it has good anti-falling and strong shock resistance capability of the charging mode led floodlight the height is 8 m i free falling body is easy and it can ensure the normal function and structure of whole.

is used when the charging mode led flood light lamp set in the opening on the ship type switch not only can be used which can rotate led lamp outer shell i for adjusting the light direction of it is convenient to use.

this utility model claims a rubber sealing ring i has two 3 4 5 6 7 or 8 same.

the specification in the description of the content is only to the structure of this utility model the invention is a lift. The utility model belongs to technical field of technical personnel to the invention claims a specific embodiment of the various kinds of modified or supplementing or is similar in the way of replace it will not deviate the utility model claims a structure or exceeding the claim for a defined range are corresponding it belongs to the utility model claims a protection range.

1. rechargeable this utility model claims an led flood light lamp comprises led lamp shell reflecting cup led integrated lamp core fixing frame and surface of non-light tight piece said reflecting bowl installed on the led lamp in the shell said led integrated lamp wick is installed on the reflecting bowl is the surface of the non-light tight sheet is installed on the fixing frame of the fixed frame and led lamp is connected with the shell wherein: It also comprises chargeable lithium ion battery control circuit board back cover electric box and the bottom bracket the back cover electric appliance box and led lamp is connected with the shell of said chargeable lithium ion battery and control circuit board are installed in the back cover electric appliance box in the said bottom bracket is installed on the led lamp of the outer shell of the lower part of said chargeable lithium ion battery and led integrated lamp core are connected with control circuit board is electrically connected to the.

2. According to claim i said charging mode led floodlight wherein: Also comprises at least one rubber sealing ring the rubber sealing ring installed on the led lamp shell and the surface of the transparent sheet between.

3. According to claim 1 i or said charging mode led floodlight wherein: It also comprises handle and handle of sponge cushion the handle and led lamp is connected with the shell of said handle is sleeved with sponge cushion is set on the handle.

4. according to claim 1 i or said charging mode led floodlight wherein: Said bottom bracket comprises the bracket connecting piece of the supporting bar and two of the bracket seat of said two support frame base is fixed on the bracket rod is installed on said the bracket connecting piece fixed on supporting rod the bracket connecting piece and the led lamp is connected with the shell of.

5. according to claim 1 i or said charging mode led floodlight wherein: It also comprises ship type switch the charging socket and led bicolour indicating lamp wherein said ship type switch the charging socket and led bicolour indicating lamp are installed in the back cover electric appliance box is.

6. according to claim 1 i or said charging mode led floodlight wherein: Said chargeable lithium ion battery is 18650 type lithium ion battery and/or polymer lithium ion battery.

7. according to claim 1 i or said charging mode led floodlight wherein: Said led lamp the outer shell is aluminum.

8. according to claim 1 i or said charging mode led floodlight wherein: The surface of the non-light tight sheet is made up of glass.
